(19) United States
(12) Patent Application Publication
(10) Pub. No.: US 2014/0069936 A1
(43) Pub. Date: Mar. 13, 2014

(54) WASTE CONTAINER

(71) Applicant: Rehrig Pacific Company, Los Angeles, CA (US)

(72) Inventor: Margaret McCanless, Atlanta, GA (US)

(73) Assignee: Rehrig Pacific Company, Los Angeles, CA (US)

(21) Appl. No.: 14/021,117

(22) Filed: Sep. 9, 2013

Related U.S. Application Data
(60) Provisional application No. 61/698,633, filed on Sep. 8, 2012.

(51) Int. Cl. B65F 1/14

(52) U.S. Cl. CPC B65F 1/14
USPC 220/600

(57) ABSTRACT

A container invention includes a base and a plurality of walls extending upward from the base to define a container interior. A plurality of ribs are formed on a bottom surface of the base. The plurality of ribs include a plurality of channels therethrough for drainage of liquid off the base when the container is inverted. The ribs and channels may be arranged to facilitate drainage of liquid from the base away from one wall toward another wall. When the container is inverted, an open lid of the container causes the base of the container to slope toward the second wall.

### BACKGROUND

Some waste containers, such as medical waste containers including sharps containers, are reusable. The container is collected, emptied and washed before being returned for reuse. The container may be inverted during washing so that the water, solvent, disinfectant, etc, drains out of the container.

### SUMMARY

A container according to one embodiment of the present invention includes a base and a plurality of walls extending upward from the base to define a container interior. A plurality of ribs are formed on a bottom surface of the base. The plurality of ribs include a plurality of channels therethrough for drainage of liquid off the base when the container is inverted.

The ribs and channels may optionally be arranged to facilitate drainage of liquid from the base away from a first one of the plurality of walls and toward a second one of the plurality of walls.

The ribs and channels may optionally be arranged to facilitate drainage of liquid from the base away from a first one of the plurality of walls and toward a second one of the plurality of walls when the base is tilted toward the second one of the plurality of walls.

The plurality of ribs may optionally include a peripheral rib around a periphery of the base.

The plurality of ribs may optionally include a longitudinal rib spaced inward from and generally parallel to the peripheral rib adjacent each of a pair of opposite ones of the plurality of walls.

The plurality of ribs may optionally include an annular rib and a plurality of radial ribs extending radially from the annular rib. A first radial rib of the plurality of radial ribs may optionally include a channel between the first radial rib and the annular rib. A second radial rib of the plurality of radial ribs optionally may not include a channel proximate an intersection of the second radial rib and the annular rib. The first radial rib, second radial rib and annular rib are configured to facilitate draining of liquid down along the first radial rib toward the annular rib, then along the annular rib onto the second radial rib and then down along the second radial rib.

A lid may optionally be hingeably attached to one of the plurality of walls. The base of the container may optionally be tilted toward a front wall of the plurality of walls by the lid when the container is inverted on the lid with the lid in the open position. The plurality of ribs may optionally be configured to drain liquid off the base adjacent the front wall. The container may optionally be nestable.

### BRIEF DESCRIPTION OF THE DRAWINGS

FIG. 1 is a perspective view of a container.

FIG. 2 is a perspective view of the body portion of the container of FIG. 1.

FIG. 3 shows two of the body portions of the container of FIG. 2 in a nested configuration.

FIG. 4 is a bottom perspective view of the container of FIG. 1.

FIG. 5 is a bottom view of the container of FIG. 1.

### DESCRIPTION OF A PREFERRED EMBODIMENT

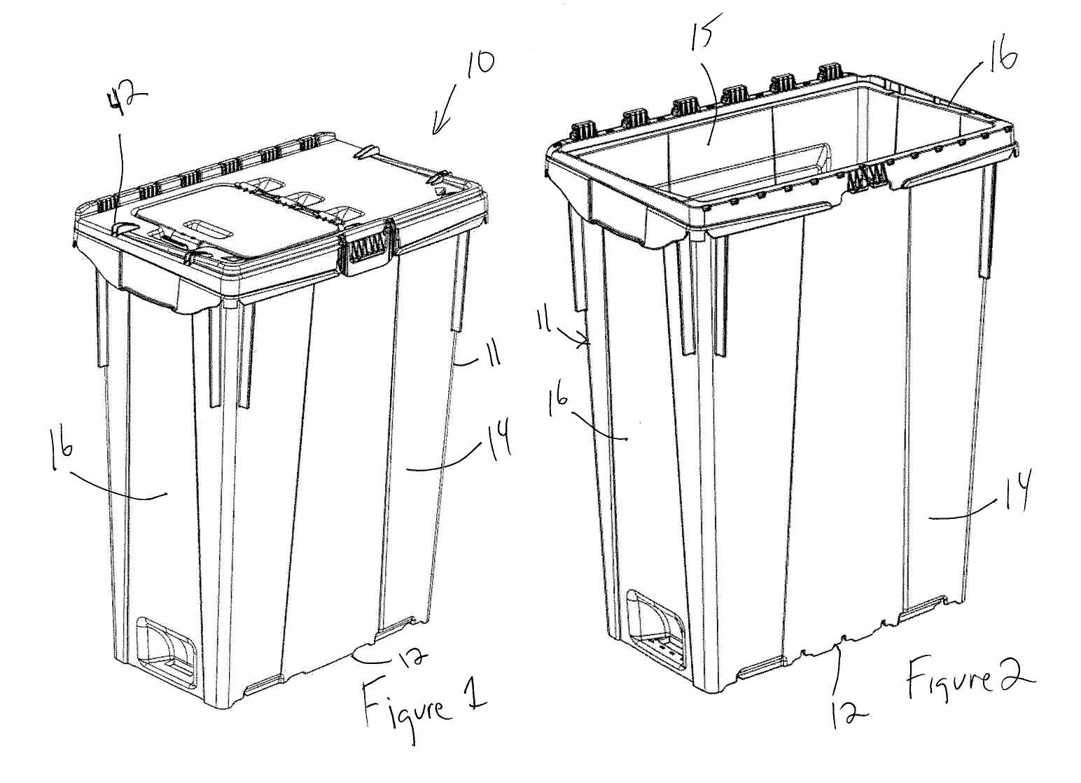

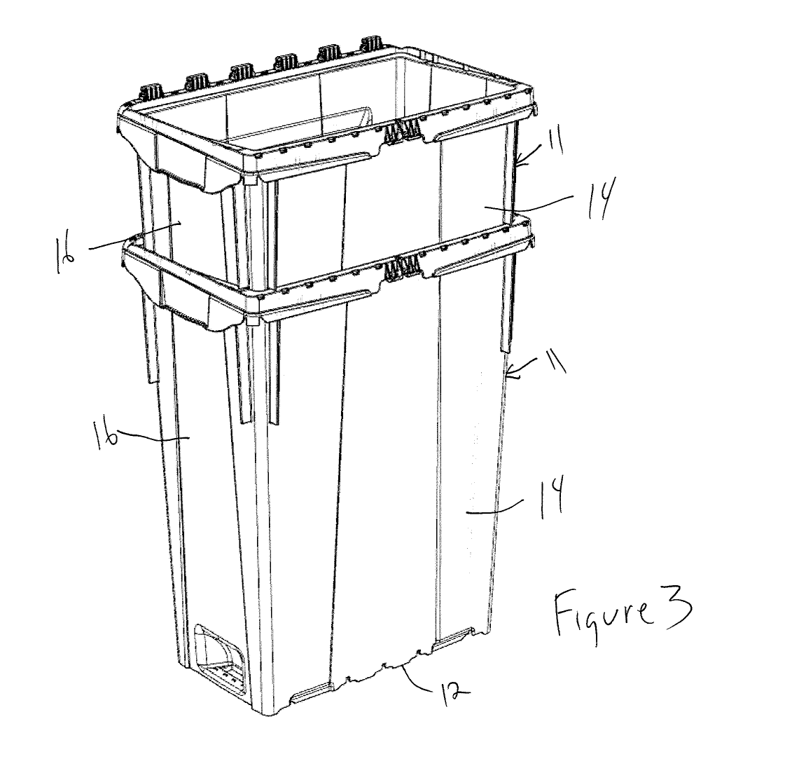

A waste container 10 according to one embodiment of the present invention is shown in FIGS. 1 and 2. The container 10 includes a body portion 11 and a lid 42 pivotably secured over an opening to the body portion 11. The body portion 11 includes a base 12 having front wall 14 and rear wall 15 and side walls 16 extending upward from a periphery of the base 12. The base 12, front wall 14 and rear walls 15 and side walls 16 are integrally molded as a single piece of plastic, such as by injection molding. The lid 42 may be separately molded of plastic.

FIG. 2 shows the body portion 11 without the lid 42. As shown in FIG. 3, the body portions 11 are nestable. The base 12 and a majority of each of the walls 14, 15, 16 of an upper body portion 11 are received within the lower body portion 11 to reduce volume for shipping and storage.

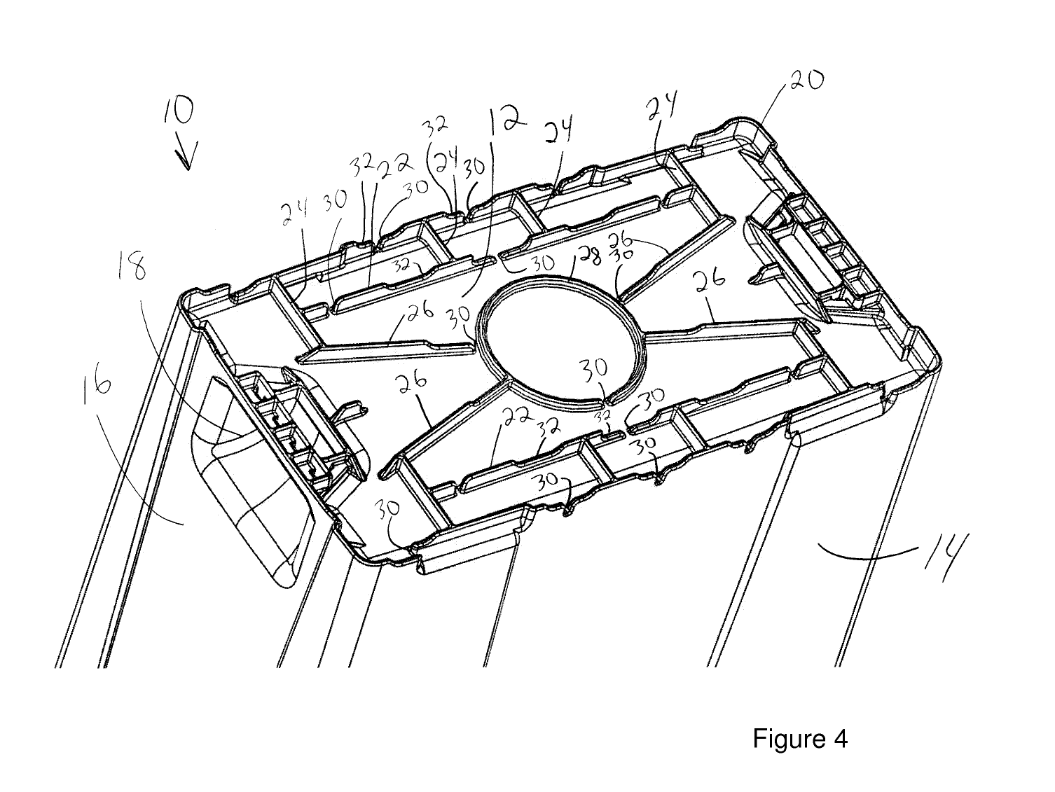

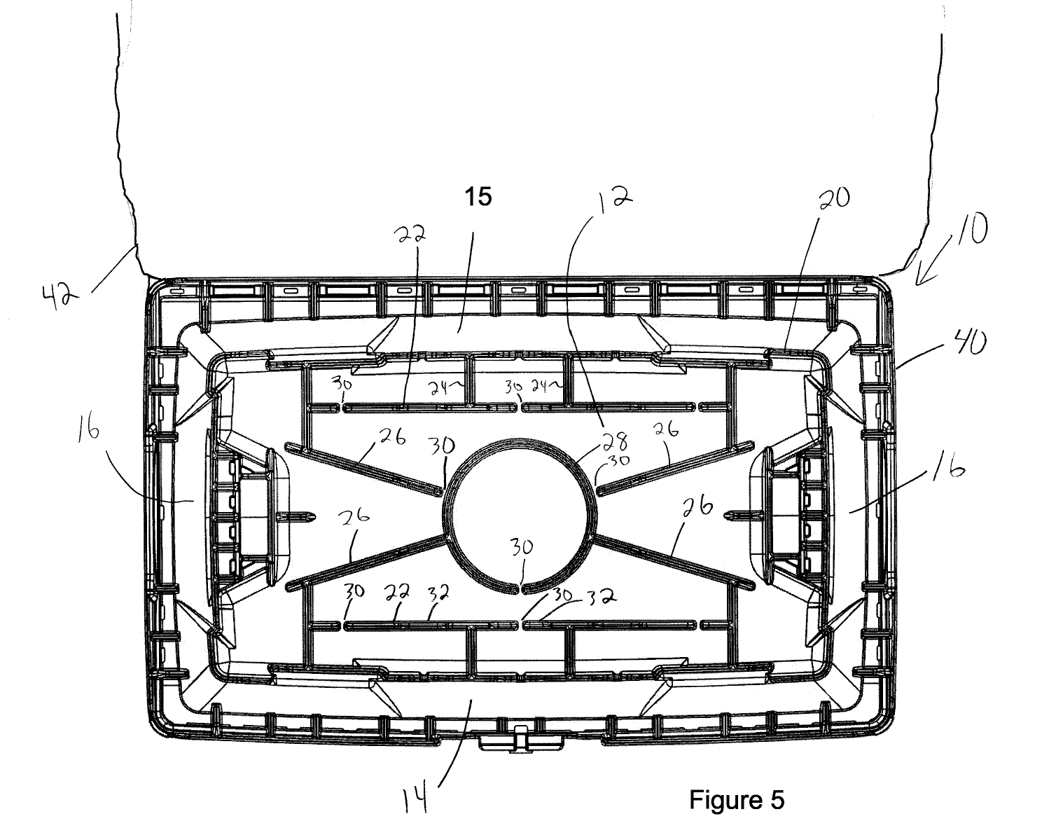

FIGS. 4 and 5 show the bottom of the base 12. The base 12 is reinforced with ribs projecting downward therefrom. The ribs include a peripheral rib 20 extending around the periphery of the base 12. A pair of longitudinal ribs 22 extend longitudinally across a portion of the base 12 parallel to the front wall 14 and rear wall 15 and spaced inward from the peripheral rib 20. A plurality of transverse ribs 24 connect the peripheral rib 20 to the longitudinal ribs 22. A plurality of radial ribs 26 extend radially from an annular rib 28 in the center portion of the base 12. The ribs are all integrally molded with the base 12.

As shown, most of the ribs 20, 22, 24, 26, 28 include at least one channel 30 or opening formed therethrough. The channels 30 extend down to the lower planar surface of the base 12. The channels 30 and ribs 20, 22, 24, 26, 28 are arranged such that when the container 10 is inverted and tilted toward the front wall 14 as shown in FIG. 1, any liquid on the base 12 will not be trapped by the ribs 22. The channels 30 and ribs are arranged such that any liquid on the base 12 will have a path off of the base 12, i.e. ultimately through the peripheral rib 20 adjacent the front wall 14.

The lid 42 (FIG. 5) is hingeably attached at the rear of the container 10, such as to the rear of the lip 40 at the upper edge of the container 10. When the container 10 is inverted onto the lid in the open position, the base 12 of the container 10 will naturally be tilted toward the front wall 14.

As a compromise between drainage and stiffness in the base, the example container 10 has ribs and channels 30 arranged so that the liquid is only ensured to have a path off the base 12 when the base 12 is tilted toward the front wall 14, not the rear wall 15 or the side walls 16. This reduces the number of channels 30 that are necessary. For example, it will be noted that the channels 30 are formed between each of two of the radial ribs 26 and the annular rib 28 for the two radial ribs 26 that would slope downward toward the annular rib 28 when the base 12 is tilted toward the front wall 14. However, there is no channel 30 between the annular rib 28 and the two radial ribs 26 that would slope downward away from the annular rib 28.

For example, even liquid between the longitudinal rib 22 near the rear wall 15 will drain though channel 30 through the longitudinal rib 22, then downward (and inward toward the center of the base 12, i.e. annular rib 28) along one of the radial ribs 26 or down the upper half of the annular rib 28 through a channel 30 between the annular rib 28 and the radial rib 26. The liquid will then travel downward along lower radial ribs 26 (away from annular rib 28 and away from the center of the base 12) and then off the base 12 via channels 30 through the peripheral rib 20.

As another example, the annular rib 28 includes a channel 30 therethrough on the front wall 14 side, such that any liquid in the annular rib 28 will exit via the channel 30, then through a channel 30 through the longitudinal rib 22 and then off the base 12 through a channel 30 through the peripheral rib 20.

In the example shown, channels 30 are formed through the peripheral rib 20 adjacent the front wall 14 and adjacent the rear wall 15, but the channels 30 adjacent the rear wall 15 could be eliminated.

As shown, liquid on the rear half of the base 12 can drain through the channels 30 all the way through the peripheral rib 20 and off the base 12 adjacent the front wall 14.

It is also possible to add additional channels 30 so that liquid would have a path off the base 12 when tilted toward the rear wall 15. As yet another alternative, sufficient channels 30 could be added so that liquid would have a path off the base 12 even when the base 12 is tilted toward either of the side walls 16. Again, however, it is preferred that the channels 30 and ribs are arranged so that drainage is only ensured when the container 10 is tilted toward the front wall, because it will naturally do so, due to the presence of the lid 42, while providing as much reinforcement as possible.

In use, the container 10 may be used for waste, such as medical waste. Periodically, the container 10 is collected, emptied and washed before being returned for reuse. The container 10 is inverted during washing (as shown in FIGS. 4 and 5) so that the water, solvent, disinfectant, etc, drains out of the container. The liquid also drains off the base 12 through the channels 30 and through the peripheral rib 20 adjacent the front wall 14.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A container comprising:
a base;
a plurality of walls extending upward from the base to define a container interior; and
a plurality of ribs on a bottom surface of the base, the plurality of ribs including a plurality of channels therethrough for drainage of liquid off the base when the container is inverted.

2. The container of claim 1 wherein the ribs and channels are arranged to facilitate drainage of liquid from the base away from a first one of the plurality of walls and toward a second one of the plurality of walls.

3. The container of claim 1 wherein the ribs and channels are arranged to facilitate drainage of liquid from the base away from a first one of the plurality of walls and toward a second one of the plurality of walls when the base is tilted toward the second one of the plurality of walls.

4. The container of claim 1 wherein the plurality of ribs includes a peripheral rib around a periphery of the base.

5. The container of claim 1 wherein the plurality of ribs includes a longitudinal rib spaced inward from and generally parallel to the peripheral rib adjacent each of a pair of opposite ones of the plurality of walls.

6. The container of claim 1 wherein the plurality of ribs includes an annular rib and a plurality of radial ribs extending radially from the annular rib.

7. The container of claim 6 wherein a first radial rib of the plurality of radial ribs includes a channel between the first radial rib and the annular rib and wherein a second radial rib of the plurality of radial ribs does not include a channel proximate an intersection of the second radial rib and the annular rib.

8. The container of claim 7 wherein the first radial rib, second radial rib and annular rib are configured to facilitate draining of liquid down along the first radial rib toward the annular rib, then along the annular rib onto the second radial rib and then down along the second radial rib.

9. The container of claim 8 further including a lid hingeably attached to one of the plurality of walls.

10. The container of claim 9 wherein the base of the container is tilted toward a front wall of the plurality of walls by the lid when the container is inverted on the lid in an open position and wherein the plurality of ribs are configured to drain liquid off the base adjacent the front wall.

11. The container of claim 9 wherein the container is nestable.

12. A container comprising:
a base;
a plurality of walls extending upward from the base to define a container interior, the plurality of walls including a front wall opposite a rear wall and a pair of opposed side walls;
a plurality of ribs on a bottom surface of the base, the plurality of ribs including a plurality of channels therethrough for drainage of liquid off the base when the container is inverted; and
a lid hingeably attached to the rear wall.

13. The container of claim 12 wherein the ribs and channels are arranged to facilitate drainage of liquid from the base away from the rear wall and toward the front wall when the base is tilted toward the front wall, wherein the base is tilted toward the front wall when the container is inverted on the lid in an open position.

14. The container of claim 13 wherein the plurality of ribs includes a peripheral rib around a periphery of the base.

15. The container of claim 14 wherein the plurality of ribs includes a pair of longitudinal ribs each spaced inward from and generally parallel to the peripheral rib adjacent the front wall and the rear wall, respectively.

16. The container of claim 15 wherein the plurality of ribs includes an annular rib and a plurality of radial ribs extending radially from the annular rib.

17. The container of claim 16 wherein a first radial rib of the plurality of radial ribs includes a channel between the first radial rib and the annular rib and wherein a second radial rib of the plurality of radial ribs does not include a channel proximate an intersection of the second radial rib and the annular rib.

18. The container of claim 17 wherein the first radial rib, second radial rib and annular rib are configured to facilitate draining of liquid down along the first radial rib toward the annular rib, then along the annular rib onto the second radial rib and then down along the second radial rib.

19. The container of claim 18 wherein the container is nestable.
